(19) United States
(12) Patent Application Publication
(10) Pub. No.: US 2023/0327471 A1
(43) Pub. Date: Oct. 12, 2023

(54) ELECTRONIC APPARATUS, EXTERNAL APPARATUS, CHARGING SYSTEM, CHARGING METHOD, AND NON-TRANSITORY COMPUTER-READABLE STORAGE MEDIUM

(71) Applicant: CASIO COMPUTER CO., LTD., Shibuya-ku, Tokyo (JP)

(72) Inventors: Hideo SUZUKI, Ome-shi, Tokyo (JP); Masanori ISHIHARA, Hamura-shi, Tokyo (JP)

(73) Assignee: CASIO COMPUTER CO., LTD., Shibuya-ku, Tokyo (JP)

(21) Appl. No.: 18/023,409

(22) PCT Filed: Aug. 12, 2021
(86) PCT No.: PCT/JP2021/029713

§ 371 Date: Feb. 27, 2023

(30) Foreign Application Priority Data
Sep. 17, 2020 (JP) 2020-156014

(51) Int. Cl. H02J 7/00

(52) U.S. Cl. CPC H02J 7/00716; H02J 7/0048; H02J 7/0036

(57) ABSTRACT

An electronic apparatus includes a connector to be connected to an external apparatus, a second measurer which measures current flowing through a secondary battery, the secondary battery being supplied with power by being electrically connected to the external apparatus, or voltage at the connector, and a controller which acquires a charging state of the secondary battery and determines whether or not an abnormality has occurred to a connection state between the external apparatus and the electronic apparatus, based on the acquired charging state and a measurement result measured by the second measurer.

### TECHNICAL FIELD

The present disclosure relates to an electronic apparatus, an external apparatus, a charging system, a charging method, and a program.

### BACKGROUND ART

Secondary batteries are widely used as power sources of portable electronic apparatuses. Charging of such a secondary battery is often performed in a charging circuit incorporated in an electronic apparatus by connecting an alternating current (AC) adapter to the electronic apparatus. In this case, when an abnormality, such as a contact failure, occurs to a connector used to connect the AC adapter to the electronic apparatus, the secondary battery cannot be normally charged. In order to prevent such an abnormality in charging, in, for example, Patent Literature 1, an electronic apparatus capable of notifying a user of a short-circuit abnormality inside a connector at the time of charging is disclosed.

### CITATION LIST

### Patent Literature

Patent Literature 1: Unexamined Japanese Patent Application Publication No. 2015-8582

### SUMMARY OF INVENTION

### Technical Problem

The electronic apparatus disclosed in Patent Literature 1 detects an abnormality in a connector by comparing applied voltage (or applied current) to a load with a predetermined standard threshold. However, there is a problem in that, since only one standard threshold is defined, detection of an abnormality cannot be successfully performed depending on a state of charging.

The present disclosure has been made in consideration of the above situation, and an objective of the present disclosure is to provide an electronic apparatus, an external apparatus, a charging system, a charging method, and a program capable of detecting an increase in contact resistance at a connector more securely.

### Solution to Problem

In order to achieve the above-described objective, an electronic apparatus according to the present disclosure includes:

a connector to be connected to an external apparatus;

a measurer which measures current flowing through a secondary battery, the secondary battery being supplied with power by being electrically connected to the external apparatus, or voltage at the connector; and

a controller which

acquires a charging state of the secondary battery, and

determines whether or not an abnormality has occurred to a connection state between the external apparatus and the electronic apparatus, based on the acquired charging state and a measurement result measured by the measurer.

### Advantageous Effects of Invention

According to the present disclosure, it is possible to detect an increase in contact resistance at a connector more securely.

### BRIEF DESCRIPTION OF DRAWINGS

FIG. 1 is a diagram illustrating a configuration example of a charging system according to Embodiment 1;

FIG. 2 is graphs illustrating an example of a relationship among input voltage, battery voltage, and charging current at the time of charging;

FIG. 3 is graphs describing reduction in the charging current in the case where contact resistance becomes large and thresholds of the charging current in respective charging states;

FIG. 4 is a graph illustrating an example of a relationship between a voltage difference (a difference between the input voltage and the battery voltage) and the charging current;

FIG. 5 is a flowchart of abnormality determination processing according to Embodiment 1;

FIG. 6 is graphs describing charging characteristics in the case where charging is performed at low temperature;

FIG. 7 is a diagram illustrating a configuration example of a charging system according to Embodiment 2;

FIG. 8 is a flowchart of abnormality determination processing according to Embodiment 2; and

FIG. 9 is a flowchart of voltage control processing according to Embodiment 2.

### DESCRIPTION OF EMBODIMENTS

Embodiments of the present disclosure are described below with reference to the drawings. Note that the same or equivalent constituent components are designated by the same reference numerals in the drawings.

### Embodiment 1

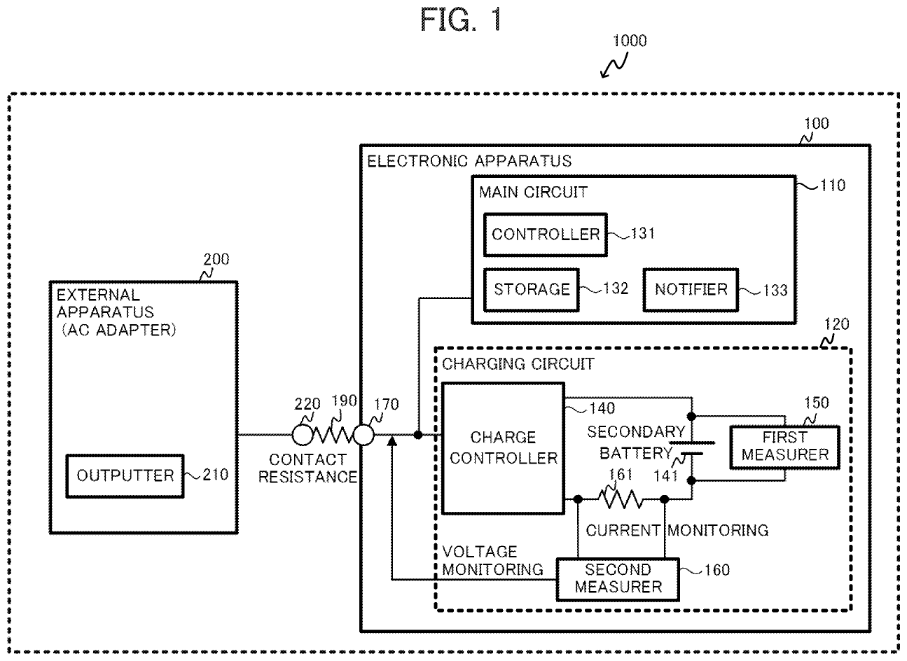

As illustrated in FIG. 1, a charging system 1000 according to Embodiment 1 includes an electronic apparatus 100 and an external apparatus 200.

The external apparatus 200 is an AC adapter that is electrically connected to and supplies power to the electronic apparatus 100. Inserting a plug that the external apparatus 200 includes into a socket causes the external apparatus 200 to supply power to the electronic apparatus 100 through a connector 220. The external apparatus 200 includes an outputter 210 to output power to be supplied to the electronic apparatus 100.

The electronic apparatus 100 is an arbitrary electronic apparatus that operates on a secondary battery (rechargeable battery), and examples of the electronic apparatus 100 include a smartwatch, an electronic watch, and an electronic dictionary. As illustrated in FIG. 1, the electronic apparatus 100 includes a controller 131, a storage 132, a notifier 133, a charge controller 140, a first measurer 150, and a second measurer 160 and is supplied with power from the external apparatus 200 through a connector 170. Note that, although, in FIG. 1, a charging circuit 120 that is a circuit to charge a secondary battery 141 and a main circuit 110 that includes circuits other than the charging circuit 120 are illustrated in distinction from each other for the purpose of convenience, this distinction is not a strict one. For example, some constituent components (for example, the controller 131) existing in the main circuit 110 also perform control of the charging circuit 120.

The controller 131 includes a processor, such as a central processing unit (CPU). The controller 131 controls the electronic apparatus 100 by executing programs stored in the storage 132.

The storage 132 includes a memory, such as a read only memory (ROM) and a random access memory (RAM), and stores programs that the CPU of the controller 131 executes and data necessary in the execution.

The notifier 133 includes a light emitting diode (LED), a liquid crystal display panel, a buzzer, or the like and notifies an abnormality or the like in a connection state between the external apparatus 200 and the electronic apparatus 100.

The charge controller 140 includes a charge control integrated circuit (IC) and the like and supplies power acquired from the external apparatus 200 through the connector 170 to the secondary battery 141 and charges the secondary battery 141 by a constant current constant voltage (CCCV) charging method.

The first measurer 150 includes a battery voltage measurement IC (for example, a battery remaining amount gauge IC) and measures voltage of the secondary battery 141 (battery voltage). Note that the first measurer 150 may measure current flowing through the secondary battery 141 (charging current) in addition to the voltage of the secondary battery 141.

The second measurer 160 includes an ammeter or a voltmeter and measures current flowing through the secondary battery 141 or voltage at the connector 170 (input voltage). The second measurer 160 may include both ammeter and voltmeter and measure both current flowing through the secondary battery 141 and voltage at the connector 170.

In FIG. 1, the second measurer 160 measures the input voltage (monitors voltage) by measuring a potential difference between the connector 170 and the ground (GND). Although, in FIG. 1, the second measurer 160 also acquires a value of current flowing through the secondary battery 141 by measuring voltage across a resistor 161 for current monitoring, the method for acquiring the current value is not limited to this method. For example, when the first measurer 150 also measures charging current, the second measurer 160 may acquire a value of the charging current that the first measurer 150 measured as a value of current flowing through the secondary battery 141.

The secondary battery 141 is a rechargeable battery, such as a lithium-ion battery and a nickel metal hydride battery. The electronic apparatus 100 is supplied with power from the external apparatus 200 and charges the secondary battery 141 with the supplied power. Note that, although, in FIG. 1, the electronic apparatus 100 appears to include the secondary battery 141, the electronic apparatus 100 does not have to include the secondary battery 141 while the electronic apparatus 100 is not powered on. For example, it may be configured such that the electronic apparatus 100 includes a battery box into which a commercially available secondary battery 141 (a nickel metal hydride battery or the like) is to be set and a user sets a commercially available secondary battery 141 into the battery box before powering on the electronic apparatus 100.

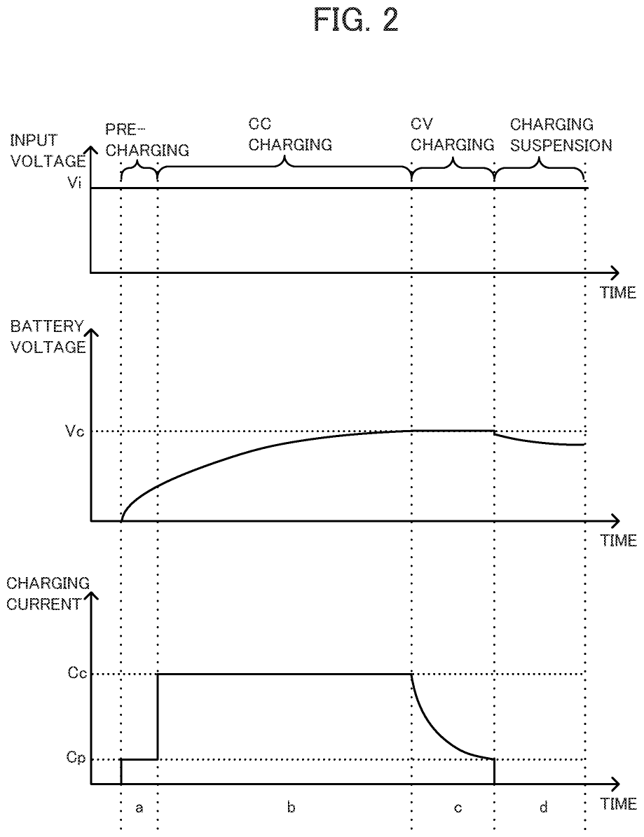

Operation of the charging circuit 120 at the time of charging the secondary battery 141 is described with reference to FIG. 2. Connecting the connector 220 of the external apparatus 200 to the connector 170 of the electronic apparatus 100 and inserting the plug of the external apparatus 200 into a socket cause the external apparatus 200 to regularly supply constant output voltage Vo to the electronic apparatus 100.

Since a voltage drop occurs due to contact resistance 190 between the connector 220 and the connector 170, the output voltage Vo of the external apparatus 200 becomes input voltage Vi at the connector 170 of the electronic apparatus 100 with a voltage equivalent to the voltage drop reduced from the output voltage Vo. However, since the value of the contact resistance 190 is generally so small as to be negligible, it can be assumed that Vo=Vi.

When a remaining amount of the secondary battery 141 is smaller than a pre-charge threshold, the charge controller 140, in order not to place a heavy load on the secondary battery 141 at the time of charging, performs pre-charging with charging current (for example, 20 mA, and, in FIG. 2, denoted by Cp) less than or equal to one fifth of charging current (for example, 125 mA, and, in FIG. 2, denoted by Cc) in regular constant current (CC) charging. When the remaining amount of the secondary battery 141 becomes greater than or equal to the pre-charge threshold, the charge controller 140 switches a charging state from the pre-charging to the CC charging. Note that, when the remaining amount of the secondary battery 141 is greater than or equal to the pre-charge threshold at a point in time when charging is started, the pre-charging is not performed and the CC charging is performed from the beginning.

In the CC charging, the charge controller 140 charges the secondary battery 141 with constant charging current (for example, 125 mA, and, in FIG. 2, denoted by Cc). When output voltage of the secondary battery 141 reaches a switching voltage (in FIG. 2, denoted by Vc) by the CC charging, the charge controller 140 switches the charging state from the CC charging to constant voltage (CV) charging.

In the CV charging, the charge controller 140 charges the secondary battery 141 with constant voltage (in FIG. 2, denoted by Vc). Although, when the CV charging is performed, the charging current flowing through the secondary battery 141 becomes smaller over time, the charge controller 140 ends the charging of the secondary battery 141 when the charging current reaches a charging end current value (for example, 20 mA, and, in FIG. 2, denoted by Cp).

The charge controller 140 grasps a present charging state (pre-charging, CC charging, CV charging, or charging suspension) as described above and stores the charging state in a specific register that the charge control IC includes. Therefore, the controller 131 is capable of acquiring a present charging state by reading a value in the specific register in the charge control IC that the charge controller 140 includes. In addition, since, as illustrated in FIG. 2, the charging state changes based on changes in the battery voltage and the charging current, the controller 131 is also capable of acquiring a charging state, based on a measurement result measured by the first measurer 150. Note that, in FIG. 2, a time period of the pre-charging, a time period of the CC charging, a time period of the CV charging, and a time period of the charging suspension are denoted by a, b, c, and d, respectively.

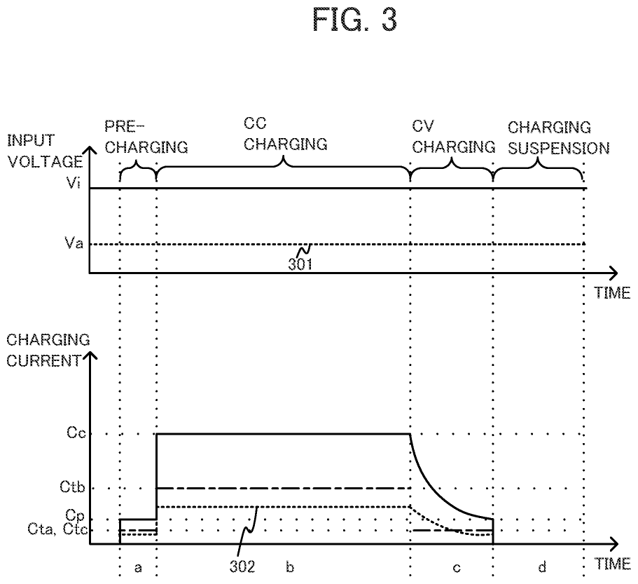

When the contact resistance 190 is so small as to be negligible, the charging is normally performed as illustrated in FIG. 2. When the contact resistance 190 is large, however, input voltage Va at the connector 170 becomes smaller than the original value Vi (=Vo) as illustrated by a dotted line 301 and the current flowing through the secondary battery 141 (charging current) also becomes smaller than the original values as illustrated by a dotted line 302, as illustrated in FIG. 3. Then, a problem (charging abnormality), such as time required for charging becoming long and the charging remaining incomplete, occurs.

In order to determine an occurrence of such a charging abnormality, the controller 131 compares a measurement result measured by the second measurer 160 with a threshold matching a charging state, and, when the measurement result is smaller than the threshold, the controller 131 determines that a charging abnormality has occurred.

Although, as a measurement result measured by the second measurer 160, two types of measurement results, namely measured current flowing through the secondary battery 141 (charging current) and measured voltage at the connector 170 (input voltage), exists, a case where the charging current is measured and the measurement result is compared with a threshold matching a charging state is first described herein. That is, when the charging state is the pre-charging, a measurement result is compared with a threshold Cta at the time of the pre-charging (for example, one half of the charging current Cp at the time of the pre-charging), when the charging state is the CC charging, a measurement result is compared with a threshold Ctb at the time of the CC charging (for example, one half of the charging current Cc at the time of the CC charging), and, when the charging state is the CV charging, a measurement result is compared with a threshold Ctc at the time of the CV charging (for example, one half of the charging end current, and, although Cta and Ctc are set as Cta=Ctc in FIG. 3, the setting is not limited thereto). When the magnitude of the charging current is smaller than a threshold, the controller 131 determines that a problem has occurred.

Note that, since, when the contact resistance 190 is large and the input voltage Va is significantly smaller than the original value Vi from the beginning as illustrated in a graph of the input voltage in FIG. 3, the charging current becomes significantly small, the CC charging in practice does not end or comes to require a longer time to switch to the CV charging. However, in FIG. 3, in order to illustrate that the charging current becomes small regardless of timing at which the contact resistance 190 has become large, the graph of the charging current is illustrated by the dotted line 302, assuming that the charging state is switched from the CC charging to the CV charging in approximately the same period of time as that in the case of FIG. 2.

Next, a case where the input voltage at the connector 170 is measured as a measurement result measured by the second measurer 160 and the measurement result is compared with a threshold matching a charging state is described. In order to make this description, first, a relationship between a difference between the input voltage Vi and battery voltage Vc (voltage difference Dv) and the charging current of the secondary battery 141 is described.

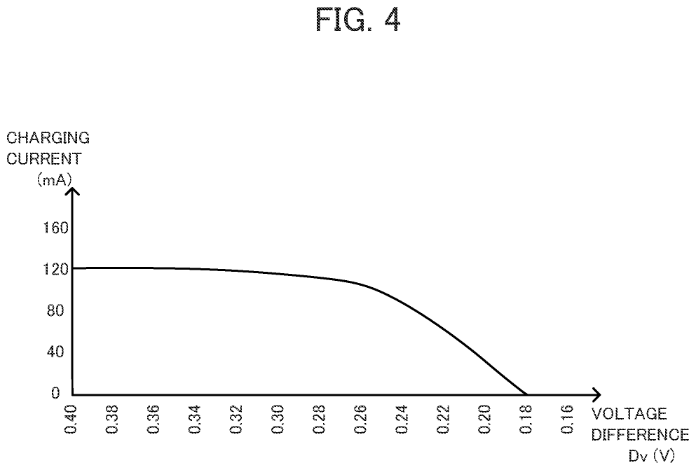

When the voltage difference Dv becomes less than or equal to a certain value, the charging current flowing through the secondary battery 141 becomes substantially zero, as illustrated in FIG. 4, and the secondary battery 141 ceases to be charged. In the example illustrated in FIG. 4, when the voltage difference Dv is greater than or equal to approximately 0.192 V, a current of 20 mA (the charging current Cp at the time of the pre-charging) can be flowed. However, when the voltage difference Dv becomes, for example, less than 0.186 V, the charging current becomes less than 10 mA (the threshold Cta at the time of the pre-charging). Therefore, at the time of the pre-charging, the threshold of voltage is set in such a way that, when the voltage difference Dv becomes less than 0.186 V, it is determined that a problem has occurred. In addition, in order to simplify the determination processing, a value obtained by subtracting a voltage difference Dv (in FIG. 4, 0.186 V) causing the charging current to be Cta from a maximum battery voltage Vc may be set as a threshold Vta of voltage at the time of the pre-charging.

In addition, in the example illustrated in FIG. 4, when the voltage difference Dv is greater than or equal to approximately 0.36 V, a current of 125 mA (the charging current Cc at the time of the CC charging) can be flowed. However, when the voltage difference Dv becomes, for example, less than 0.22 V, the charging current becomes less than 62.5 mA (the threshold Ctb at the time of the CC charging). Therefore, at the time of the CC charging, the threshold of voltage is set in such a way that, when the voltage difference Dv becomes less than 0.22 V, it is determined that a problem has occurred.

In addition, in order to simplify the determination processing, a value obtained by subtracting a voltage difference Dv (in FIG. 4, 0.22 V) causing the charging current to be Ctb from the maximum battery voltage Vc may be set as a threshold Vtb of voltage at the time of the CC charging.

A threshold at the time when the charging state is the CV charging can also be set in the manner described above. However, values illustrated in FIG. 4 are only an example, and the above-described values need to be adjusted according to characteristics of the secondary battery 141 and electronic components that are actually used.

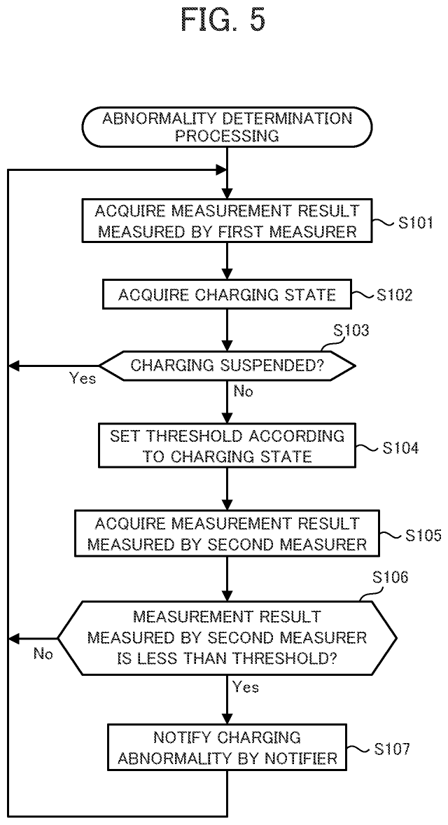

Next, abnormality determination processing that the electronic apparatus 100 executes is described with reference to FIG. 5. Execution of this processing is started when the electronic apparatus 100 is powered on.

First, the controller 131 acquires a measurement result measured by the first measurer 150 (step S101). Next, the controller 131 acquires a present charging state (step S102). Step S102 is also referred to as a state acquisition step. Note that the controller 131 may acquire a charging state, based on a measurement result measured by the first measurer 150 or may directly acquire a charging state from the charge controller 140 (by reading a value in the specific register in the charge control IC or the like). When the controller 131 directly acquires a charging state from the charge controller 140, step S101 is unnecessary.

Then, the controller 131 determines whether or not the secondary battery 141 is being charged, based on the acquired charging state (step S103). When the charging is suspended (step S103; Yes), the controller 131 returns to step S101.

When the charging is not suspended (step S103; No), the controller 131 sets a threshold according to the charging state acquired in step S102 (step S104). For example, as a threshold of the charging current, the controller 131 sets Cta (for example, 10 mA) when the charging state is the pre-charging, sets Ctb (for example, 62.5 mA) when the charging state is the CC charging, or sets Ctc (for example, 10 mA) when the charging state is the CV charging.

Then, the controller 131 acquires a measurement result measured by the second measurer 160 (step S105). Step S105 is also referred to as a measurement step. Next, the controller 131 determines whether or not the measurement result measured by the second measurer 160 is less than the threshold (step S106). Step S106 is also referred to as a determination step. In step S106, the controller 131, for example, determines whether or not the charging current flowing through the secondary battery 141 that was measured by the second measurer 160 is less than the threshold (Cta, Ctb, or Ctc) matching the charging state.

When the measurement result measured by the second measurer 160 is greater than or equal to the threshold (step S106; No), the controller 131 returns to step S101. When the measurement result measured by the second measurer 160 is less than the threshold (step S106; Yes), the controller 131 determines that a problem has occurred and notifies a charging abnormality by the notifier 133 (step S107). For example, the controller 131 turns on the LED of the notifier 133 or sounds the buzzer of the notifier 133. Then, the controller 131 returns to step S101.

Since, through the abnormality determination processing described above, the electronic apparatus 100 can determine an abnormality, based on the threshold matching the charging state, the electronic apparatus 100 is capable of detecting an increase in the contact resistance at a connector more surely. In addition, the electronic apparatus 100 is capable of notifying the user that a charging abnormality has occurred by the notifier 133.

Variation 1

The electronic apparatus 100 may include a temperature sensor, such as a thermistor, as means for acquiring temperature of the battery (temperature acquisition means). The charge controller 140 may control the charging voltage and the charging current, based on the temperature that the temperature acquisition means acquired. This is because, in an environment in which temperature is extremely low or extremely high, charging of the secondary battery 141 becomes less efficient or the secondary battery 141 becomes unable to be normally charged.

For example, it may be configured such that the charge controller 140 suspends charging when the temperature is less than 0 degrees Celsius or greater than or equal to 60 degrees Celsius and performs charging with the charging voltage set to a voltage lower than a voltage under normal conditions (for example, a voltage of 95% of a voltage under normal conditions) when the temperature is greater than or equal to 0 degrees Celsius and less than 10 degrees Celsius or greater than or equal to 45 degrees Celsius and less than 60 degrees Celsius.

In this case, the controller 131 also acquires temperature of the battery in, for example, step S101 in FIG. 5. When the temperature is less than 0 degrees Celsius or greater than or equal to 60 degrees Celsius, the controller 131 returns to step S101 in step S102 in FIG. 5 (because the charging is suspended). When the temperature is greater than or equal to 0 degrees Celsius and less than 10 degrees Celsius or greater than or equal to 45 degrees Celsius and less than 60 degrees Celsius, the controller 131 sets the threshold of the charging voltage in consideration of the fact that the charging voltage is lower than a voltage under normal conditions, in step S103.

As another example, it may be configured such that the charge controller 140 suspends charging when the temperature is less than 0 degrees Celsius or greater than or equal to 60 degrees Celsius, performs charging with the charging current set to a current lower than a current under normal conditions (for example, a current of 60% of a current under normal conditions) when the temperature is greater than or equal to 0 degrees Celsius and less than 10 degrees Celsius, and performs charging with the charging voltage set to a voltage lower than the voltage under normal conditions (for example, a voltage of 95% of the voltage under normal conditions) when the temperature is greater than or equal to 45 degrees Celsius and less than 60 degrees Celsius.

In this case, the controller 131 also acquires temperature of the battery in, for example, step S101 in FIG. 5. When the temperature is less than 0 degrees Celsius or greater than or equal to 60 degrees Celsius, the controller 131 returns to step S101 in step S102 in FIG. 5 (because the charging is suspended). When the temperature is greater than or equal to 0 degrees Celsius and less than 10 degrees Celsius, the controller 131 sets the threshold of the charging current in consideration of the fact that the charging current is lower than the current under normal conditions, in step S103, and, when the temperature is greater than or equal to 45 degrees Celsius and less than 60 degrees Celsius, the controller 131 sets the threshold of the charging voltage in consideration of the fact that the charging voltage is lower than the voltage under normal conditions, in step S103.

Performing the abnormality determination processing with the temperature taken into consideration as described above enables an increase in the contact resistance at a connector to be detected more surely even when the charging current and the charging voltage change according to the temperature.

Variation 2

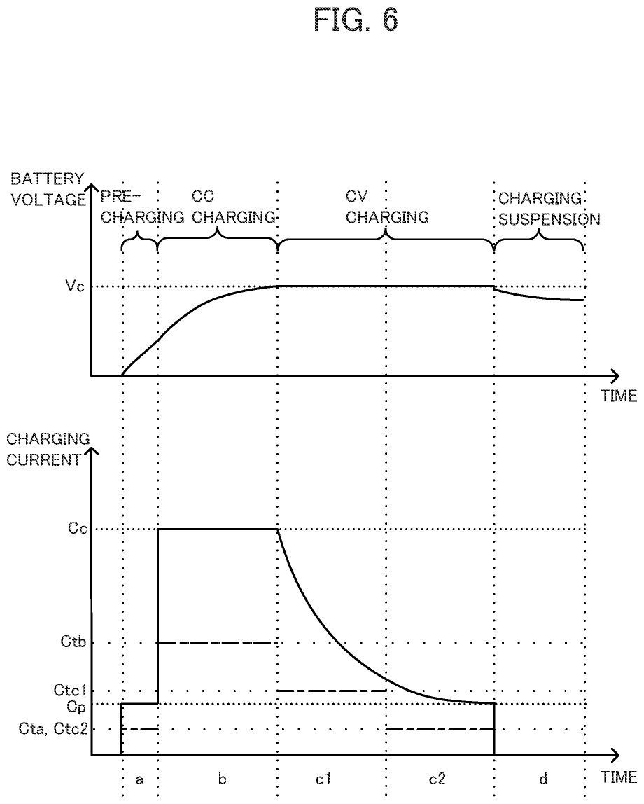

Charging characteristics of the secondary battery 141 differ depending on temperature. For example, while, at a room temperature (for example, 23 degrees Celsius), a ratio between a period of the CC charging and a period of the CV charging indicates that the period of CC charging is longer than the period of the CV charging as illustrated in FIG. 2, at a low temperature (for example, 6 degrees Celsius), the ratio between the period of the CC charging and the period of the CV charging indicates that the period of the CV charging is longer than the period of the CC charging as illustrated in FIG. 6.

Thus, thresholds during the time period of the CV charging may be set at multiple levels. For example, it may be configured such that, as illustrated in FIG. 6, a threshold of the charging current immediately after the charging state is switched to the CV charging is set to a threshold Ctc1 that is approximately one half of the Ctb value and, at an intermediate time point (for example, at a time point at which a time one-half a time that is expected to be a time required for the CV charging has passed), the threshold of the charging current is changed to a threshold Ctc2 that is a value approximately one-half the charging end current. Setting thresholds during the time period of the CV charging at multiple levels as described above enables an occurrence of a problem (an increase in the contact resistance 190) to be determined comparatively quickly even when the problem occurred immediately after the charging state was switched to the CV charging.

Note that, although, in FIG. 6, thresholds during the time period of the CV charging are set to two levels (Ctc1 and Ctc2), the thresholds may be set to three or more levels. In addition, thresholds during the time period of the CV charging may be set at multiple levels regardless of temperature (for example, also at a room temperature).

### Embodiment 2

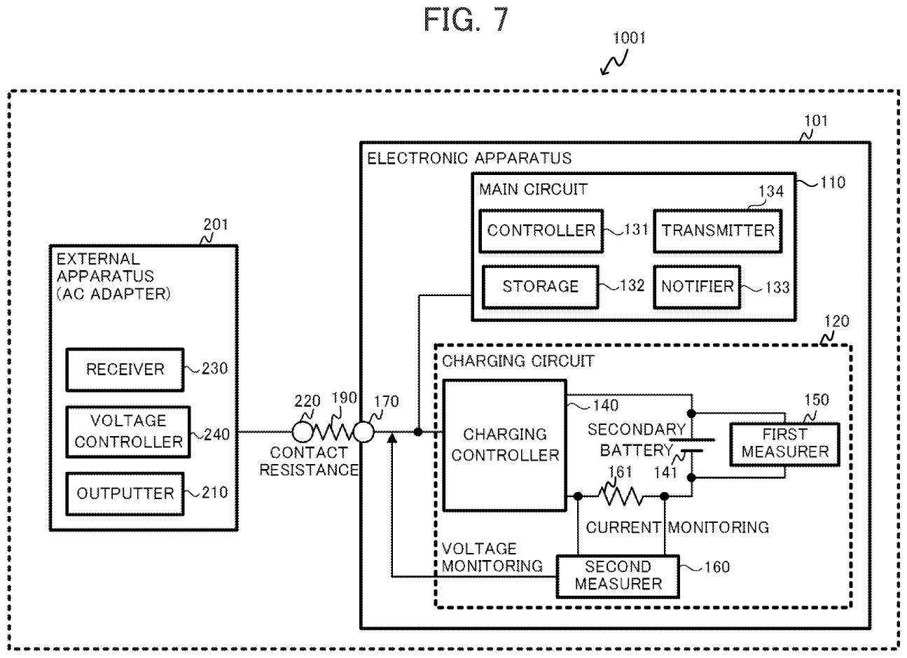

Embodiment 2 in which, at the time of occurrence of a problem, an external apparatus increases output voltage through communication between an electronic apparatus and the external apparatus is described below. As illustrated in FIG. 7, a charging system 1001 according to Embodiment 2 includes an electronic apparatus 101 and an external apparatus 201.

The electronic apparatus 101 has a configuration in which a transmitter 134 is added to the electronic apparatus 100 according to Embodiment 1. In addition, the external apparatus 201 has a configuration in which a receiver 230 and a voltage controller 240 are added to the external apparatus 200 according to Embodiment 1.

The transmitter 134 includes a communication device and transmits a notification signal to the receiver 230. In addition, the receiver 230 also includes a communication device and receives a notification signal sent from the transmitter 134. The notification signal is described later. Note that the transmitter 134 and the receiver 230 can use an arbitrary communication method. For example, the transmitter 134 and the receiver 230 may communicate with each other using a wireless communication method, such as a wireless local area network (LAN), or a wired communication method, such as a universal serial bus (USB).

In addition, when the transmitter 134 and the receiver 230 communicate with each other using a wired communication method, the electronic apparatus 101 and the external apparatus 201 may include a cable for communication in parallel with a power cable connected via a connector 170 and a connector 220 or may include a cable for communication independently of a power cable. In addition, the transmitter 134 and the receiver 230 may communicate with each other by using only a power cable and superimposing a notification signal on power flowing through the power cable. However, when the transmitter 134 and the receiver 230 communicate with each other using a wired communication method, it is required to take a measure to prevent an error from occurring in the communication of a notification signal even when contact resistance 190 becomes large. Therefore, when the contact resistance 190 is taken into consideration, the transmitter 134 and the receiver 230 preferably communicate with each other wirelessly.

The voltage controller 240 includes a processor, such as a CPU, and a memory, and controls the magnitude of voltage that the outputter 210 outputs according to a notification signal that the receiver 230 received. Specifically, the voltage controller 240 enables power supply to the electronic apparatus 101 to be performed at a higher voltage by increasing output voltage output from the outputter 210 by an amount equivalent to a voltage notified by the notification signal.

The notification signal is described below. The notification signal is a signal for notifying the external apparatus 201 of a voltage increase value Vu (a value indicating by what amount the output voltage needs to be increased from a regular voltage). The voltage increase value is calculated by the controller 131 from a present charging state, input voltage, and battery voltage, based on a relationship between a voltage difference Dv (a difference between the input voltage and the battery voltage) and charging current as illustrated in FIG. 4.

For example, while input voltage Vi decreases when the contact resistance 190 increases, when, as a result, a difference between the input voltage Vi and battery voltage Vc (voltage difference Dv) becomes less than or equal to a certain value, the charging current flowing through a secondary battery 141 becomes substantially zero as illustrated in FIG. 4 and the secondary battery 141 ceases to be charged. In order to prevent the secondary battery 141 from ceasing to be charged in this way, the electronic apparatus 101 prevents the voltage difference Dv from becoming less than or equal to a certain value by causing the external apparatus 201 to increase output voltage Vo by means of a notification signal.

For example, in the example illustrated in FIG. 4, when the voltage difference Dv is greater than or equal to approximately 0.192 V, a current of 20 mA (charging current Cp at the time of pre-charging) can be flowed. However, when the voltage difference Dv becomes less than 0.186 V, the charging current becomes less than 10 mA (a threshold Cta at the time of pre-charging). Therefore, it is considered that, in the case where the voltage difference Dv is less than 0.192 V, increasing the output voltage Vo of the external apparatus 201 by a voltage calculated by 0.192-Dv causes the input voltage Vi to also increase in response to the increase in the output voltage Vo and the voltage difference Dv to become approximately 0.192 V and thereby enables the charging current Cp at the time of the pre-charging to be maintained In other words, in the case of the secondary battery 141 having characteristics as illustrated in FIG. 4, the controller 131 controls the transmitter 134 to transmit a value calculated as a voltage increase value Vu=0.192−Dv to the receiver 230 as a notification signal, at the time of the pre-charging.

In addition, for example, in the example illustrated in FIG. 4, when the voltage difference Dv is greater than or equal to approximately 0.36 V, a current of 125 mA (charging current Cc at the time of CC charging) can be flowed. However, when the voltage difference Dv becomes less than 0.22 V, the charging current becomes less than 62.5 mA (a threshold Ctb at the time of CC charging). Therefore, it is considered that, in the case where the voltage difference Dv is less than 0.36 V, increasing the output voltage Vo of the external apparatus 201 by a voltage calculated by 0.36−Dv causes the input voltage Vi to also increase in response to the increase in the output voltage Vo and the voltage difference Dv to become approximately 0.36 V and thereby enables the charging current Cc at the time of the CC charging to be maintained In other words, in the case of the secondary battery 141 having characteristics as illustrated in FIG. 4, the controller 131 controls the transmitter 134 to transmit a value calculated as a voltage increase value Vu=0.36−Dv to the receiver 230 as a notification signal, at the time of the CC charging.

Although, when the charging state is the CV charging, necessary charging current decreases as time passes, the controller 131 is capable of calculating a voltage difference Dvr that allows necessary charging current Ct to be maintained at each point in time in the same manner as described above from, for example, the characteristics illustrated in FIG. 4 and the characteristics illustrated in FIG. 2. Then, it is considered that, in the case where the voltage difference Dv is less than Dvr, increasing the output voltage Vo of the external apparatus 201 by a voltage calculated by Dvr−Dv causes the input voltage Vi to also increase in response to the increase in the output voltage Vo and the voltage difference Dv to become approximately Dvr and thereby enables the charging current Ct at the point in time during the CV charging to be maintained In other words, at the time of the CV charging, the controller 131 controls the transmitter 134 to transmit a value calculated as a voltage increase value Vu=Dvr−Dv to the receiver 230 as a notification signal at a point in time at which the controller 131 detects a charging abnormality.

Since the other part of the configuration and the like of Embodiment 2 are the same as those of Embodiment 1, descriptions thereof are omitted.

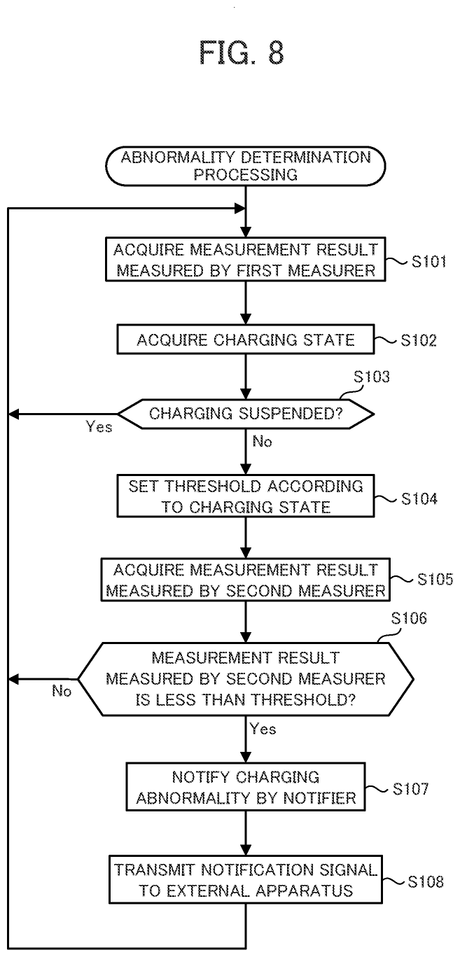

Next, abnormality determination processing that the electronic apparatus 101 executes is described with reference to FIG. 8. Execution of this processing is started when the electronic apparatus 101 is powered on. In addition, since the processing in steps S101 to S107 are the same as the abnormality determination processing according to Embodiment 1 (FIG. 5), descriptions thereof are omitted.

After step S107, the controller 131 transmits the above-described notification signal to the external apparatus 201 via the transmitter 134 (step S108). Since there is a possibility that a slight time lag is required for the output voltage from the external apparatus 201 to increase to a certain level by the notification signal sent in step S108, processing of waiting for a period of time (for example, for several seconds) after the processing in step S108 may be performed. Then, the controller 131 returns to step S101.

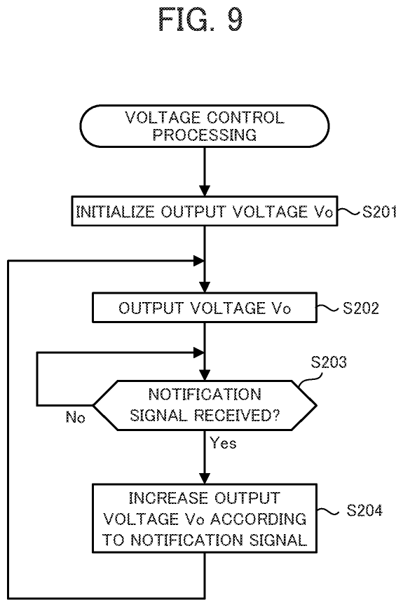

Next, voltage control processing that the external apparatus 201 executes is described with reference to FIG. 9. Execution of this processing is started when the external apparatus 201 is powered on.

First, the voltage controller 240 initializes the value of the output voltage Vo to be output from the outputter 210 to a regular voltage (for example, 5 V) (step S201).

Then, the voltage controller 240 controls the outputter 210 to output power at a voltage of the output voltage Vo (step S202). Next, the voltage controller 240 determines whether or not the receiver 230 has received a notification signal (step S203). When the receiver 230 has not received a notification signal (step S203; No), the voltage controller 240 returns to step S203 and waits until receiving a notification signal.

When the receiver 230 receives a notification signal (step S203; Yes), the voltage controller 240 increases the output voltage Vo according to the received notification signal (step S204), returns to step S202, and controls the outputter 210 to output power at the voltage of the output voltage Vo.

Note that, although, in the above-described processing, the controller 131 is configured to calculate a voltage increase value Vu and transmit the calculated voltage increase value Vu to the external apparatus 201 as a notification signal, the controller 131 does not necessarily have to calculate the voltage increase value Vu. For example, it may be configured such that, in step S108, the controller 131 does not calculate a voltage increase value Vu but transmits a notification signal simply notifying the external apparatus 201 to increase voltage and, when the voltage controller 240 receives the notification signal, the voltage controller 240 increases the output voltage Vo by an amount equivalent to a preset voltage value (for example, 1 V) in step S204.

The abnormality determination processing (FIG. 8) and the voltage control processing (FIG. 9) according to Embodiment 2 were described above. The processing enables the charging system 1001 according to Embodiment 2 to not only notify a user of an abnormality but also increase voltage to be output from the external apparatus 201 at the time of detecting an increase in contact resistance at a connector. Through this processing, the charging system 1001 can perform charging in the same charging time as that under normal conditions even while the contact resistance at a connector increases.

Note that the present disclosure is not limited to the above-described embodiments and can be subjected to various modifications. For example, it is possible to configure an embodiment in which Embodiment 2 and Variation 1 are combined with each other or an embodiment in which Embodiment 2 and Variation 2 are combined with each other.

Note that the respective functions of the electronic apparatuses 100 and 101 can be achieved by a computer, such as a general personal computer (PC). Specifically, the above-described embodiments were described assuming that programs for the abnormality determination processing that the electronic apparatus 100 or 101 executes are stored in the ROM in the storage 132 in advance. However, a computer capable of achieving the above-described respective functions may be configured by storing and distributing the programs in a non-transitory computer-readable recording medium, such as a flexible disk, a compact disc read only memory (CD-ROM), a digital versatile disc (DVD), a magneto-optical disc (MO), a memory card, and a USB memory, and reading and installing the programs in the computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2020-156014, filed on Sep. 17, 2020, the entire disclosure of which is incorporated by reference herein.

### INDUSTRIAL APPLICABILITY

The present disclosure is applicable to an electronic apparatus, an external apparatus, a charging system, a charging method, and a program capable of detecting an increase in contact resistance at a connector more surely.

### REFERENCE SIGNS LIST

100, 101 Electronic apparatus
110 Main circuit
120 Charging circuit
131 Controller
132 Storage
133 Notifier
134 Transmitter
140 Charge controller
141 Secondary battery
150 First measurer
160 Second measurer
161 Resistor
170, 220 Connector
190 Contact resistance
200, 201 External apparatus
210 Outputter
230 Receiver
240 Voltage controller
301, 302 Dotted line
1000, 1001 Charging system

1. An electronic apparatus, comprising:
a first connector to be connected to an external apparatus, the external apparatus including a second connector;
a first measurer which at least measures voltage at a secondary battery, the secondary battery being supplied with power by being electrically connected to the external apparatus;
a second measurer which at least measures current flowing through the secondary battery; and
at least one processor, wherein the at least one processor is configured to execute processing including:
acquiring a charging state of the secondary battery based on the measured voltage, and
determining whether or not an abnormality has occurred to a connection state between the external apparatus and the electronic apparatus, based on the measured current and the acquired charging state.

2. The electronic apparatus according to claim 1, wherein the processor determines whether or not the abnormality has occurred by comparing a current threshold with the measured current, the current threshold being set based on the acquired charging state.

3. The electronic apparatus according to claim 1, further comprising:
a notifier which notifies the abnormality, wherein in response to the processor determining that the abnormality has occurred, the processor makes the notifier notify the abnormality.

4. The electronic apparatus according to claim 1, further comprising:
a transmitter which transmits a notification signal to the external apparatus,
wherein in response to the processor determining that the abnormality has occurred, the processor makes the external apparatus supply power at a higher voltage for the electronic apparatus by the transmitter transmitting the notification signal to the external apparatus.

5. An external apparatus to be connected to an electronic apparatus, the external apparatus comprising:
an outputter which supplies power to the electronic apparatus;
a receiver which receives a notification signal from the electronic apparatus; and
a processor which, in response to the receiver receiving the notification signal, executes processing to increase voltage to be output from the outputter based on the notification signal.

6. A charging system, comprising:
an electronic apparatus; and
an external apparatus to electrically be connected to the electronic apparatus,
wherein the electronic apparatus includes:
a first connector to be connected to the external apparatus, the external apparatus including a second connector;
a first measurer which at least measures voltage at a secondary battery, the secondary battery being supplied with power by being electrically connected to the external apparatus;
a second measurer which at least measures current flowing the secondary battery; and
at least one processor which:
acquires a charging state of the secondary battery based on the measured voltage, and
determines whether or not an abnormality has occurred to a connection state between the external apparatus and the electronic apparatus, based on the measured current and the acquired charging state, and
wherein the external apparatus to be connected to the electronic apparatus includes:
an outputter which supplies power to the electronic apparatus.

7. A charging method of an electronic apparatus, the electronic apparatus including a first connector, the charging method comprising:
measuring voltage at a secondary battery, the secondary battery being supplied with power by being electrically connected to an external apparatus including a second connector;
measuring current flowing through the secondary battery;
acquiring a charging state of the secondary battery based on the measured voltage; and
determining whether or not an abnormality has occurred to a connection state between the external apparatus and the electronic apparatus, based on the measured content and the acquired charging state.

8. A non-transitory computer-readable storage medium storing a program, the program causing a computer of an electronic apparatus, the electronic apparatus including a first connector, to execute operations comprising:
measuring voltage at a secondary battery, the secondary battery being supplied with power by being electrically connected to an external apparatus including a second connector;
measuring current flowing through the secondary battery;
acquiring a charging state of the secondary battery based on the measured voltage; and
determining whether or not an abnormality has occurred to a connection state between the external apparatus and the electronic apparatus, based on the measured current and the acquired charging state.

9. The electronic apparatus according to claim 2, wherein the processor;
acquires, as the charging state, at least one of a constant current charging state, a constant voltage charging state, or a charging suspension state, and determines whether or not the abnormality has occurred by comparing a current threshold with the measured current, the current threshold being set based on a charging state at acquisition of the charging state among the constant current charging state, the constant voltage charging state, and the charging suspension state.

10. The electronic apparatus according to claim 9, wherein the processor sets a plurality of the current thresholds in the constant voltage charging state.

11. The electronic apparatus according to claim 10, further comprising:
a thermistor which measures temperature of the secondary battery,
wherein the processor sets a plurality of the current thresholds in the constant voltage charging state in a case in which the temperature of the secondary battery measured by the thermistor is equal to or less than a temperature threshold.

12. The charging method according to claim 7, wherein whether or not the abnormality has occurred is determined by comparing a current threshold with the measured current, the current threshold being set based on the acquired charging state.

13. The charging method according to claim 7, wherein the abnormality is notified in response to determination that the abnormality has occurred.

14. The charging method according to claim 7, wherein in response to a determination that the abnormality has occurred, the external apparatus is made to supply power at a higher voltage for the electronic apparatus by transmission of a notification signal to the external apparatus.

15. The charging method according to claim 12, wherein:
at least one of a constant current charging state, a constant voltage charging state, or a charging suspension state is acquired as the charging state, and
whether or not the abnormality has occurred is determined by comparing a current threshold with the measured current, the current threshold being set based on a charging state at acquisition of the charging state among the constant current charging state, the constant voltage charging state, and the charging suspension state.

16. The charging method according to claim 15, wherein a plurality of the current thresholds in the constant voltage charging state is set.

17. The charging method according to claim 16, wherein a plurality of the current thresholds in the constant voltage charging state is set in a case in which temperature of the secondary battery is equal to or less than a temperature threshold.
